(19) United States
(12) Patent Application Publication
(10) Pub. No.: US 2002/0187889 A1
(43) Pub. Date: Dec. 12, 2002

(54) Mixed oxide nanoparticles and apparatus for making same

(76) Inventors: Robert J. Lauf, Oak Ridge, TN (US); Tommy J. Phelps, Knoxville, TN (US); Chuanlun Zhang, Columbia, MO (US); Yul Roh, Oak Ridge, TN (US)

Correspondence Address: Gregory A. Nelson, AKERMAN, SENTERFITT & EIDSON, P.A., 222 Lakeview Avenue, Suite 400, P.O. Box 3188, West Palm Beach, FL, 33402-3188, US

(21) Appl. No.: 10/174,184

(22) Filed: Jun. 18, 2002

Related U.S. Application Data
(63) Continuation-in-part of application No. 09/428,376, filed on Oct. 28, 1999.

(51) Int. Cl. C04B 35/00

(52) U.S. Cl. 501/1

(57) ABSTRACT

An apparatus for producing mixed oxide nanoparticles uses thermophilic bacteria cultured with suitable reducible metals in the presence of an electron donor to reduce at least one metal to form mixed oxide nanoparticles. The mixed oxide nanoparticles can have a magnetism greater than magnetite, such as a line width (ΔH) of at least 2,200 Gauss. The magnetic nanoparticles can be used to form improved magnetorheological media, magnetic storage, dry printing and magnetic devices.

### CROSS-REFERENCE TO RELATED APPLICATIONS

This application is a Continuation-In-Part of application Ser. No. 09/428,376 filed on Oct. 28, 1999 entitled MIXED OXIDE NANOPARTICLES AND METHOD FOR MAKING.

### STATEMENT REGARDING FEDERALLY SPONSORED RESEARCH OR DEVELOPMENT

The United States Government has rights in this invention pursuant to Contract No. DE-AC05-00OR22725 between the United States Department of Energy and UT-Battelle, LLC.

### FIELD OF THE INVENTION

This invention relates to the field of ceramic compositions. More particularly, this invention relates to fine particulates of ceramic powders, including magnetic particulates and an apparatus including thermophilic bacteria for making the same.

### BACKGROUND OF THE INVENTION

In the production of ferrites and many other ceramics, mixed oxide powders are traditionally synthesized by mixing oxides, carbonates, and other compounds, calcining at a high temperature, and milling to reduce the particle size. This process is energy and time intensive, frequently hard to control, and sometimes must repeated several times before the final product is obtained.

Also, there is a lower practical limit on the particle size that can be achieved by mechanical milling. Grinding ceramic materials to smaller sizes requires progressively more energy due to several reasons, including the greater difficulty in milling smaller particles that have fewer strength limiting defects than coarser particles. Additionally, grinding inefficiencies become significant because of mechanical aspects related to the transfer of useful energy from the milling medium to the particles and to fluid aspects related to the transport of particles through the grinding zone in the mill. Accordingly, for any given milling approach, the required milling time increases as the desired particle size decreases. Generally, contamination of the powder increases with increasing milling time because of abrasion of material from the medium.

Alternatively, chemical routes such as precipitation, sol-gel, and the like can be employed. These processes are generally more costly than calcining, but may yield a product with a higher level of chemical homogeneity and a very fine particle size. The precipitation of iron oxides by aqueous processes generally yields ferric oxide (Fe₂O₃), which must be reduced (by heating in hydrogen, for example) if a magnetic iron oxide (Fe₃O₄) is the desired product. This treatment adds more process steps, often including a milling step to break up agglomerates formed during the reduction process.

It has been known for some time that certain bacteria reduce Fe (III) in various geochemical environments. Microbial Fe (III) reduction has been observed primarily in low temperature environments that have been extensively influenced by modern surface biogeochemical processes such as weathering or microbial metabolism. It is also known that certain bacteria such as Desulfovibrio desulfuricans reduce sulfate to sulfide under anaerobic conditions. The formation of some mineral deposits such as magnetite deposits in banded iron formations in both ancient and modern times may be attributed to the action of such bacteria.

Some magnetotactic bacteria have been reported to form magnetic nanocrystals within the cell. However, the reported ratio of product nanocrystals to biomass is relatively low, typically a few nanocrystals per cell.

Several varieties of thermophilic bacteria such as Thermoanerobacter and Thermoanerobium are known to reduce Fe (III) ions as part of their respiration processes. These bacteria have been found in core samples from two geologically and hydrologically separated sedimentary basins, the Taylorsville Basin in Virginia and the Piceance Basin in Colo. Both the Taylorsville and Piceance Basins have been isolated from surface processes for millions of years. The conditions under which the bacteria were found are summarized below in Table 1.

TABLE 1

| Locality | Taylorsville | Piceance |
|---|---|---|
| Age | Triassic | Cretaceous |
| Depth (m) | 2652-2798 | 856-2096 |
| Temperature (° C.) | 65-85 | 42-85 |
| Pressure (Mpa*) | 30-35 | |

*Mpa, Megapascal, 10⁶ Pa

The differences in thermophiles found in hot springs in comparison with deep subsurface include environmental conditions such as pressure, nutrients and evolution. The actual differences between the microorganisms may be minor; however, thermophiles from hot springs have not yet been demonstrated to produce mixed oxides.

It is known that the bacteria appear to utilize any of several electron donors such as formate, acetate, lactate, pyruvate, or hydrogen, provided that an electron acceptor such as amorphous Fe(III) oxyhydroxide is present. Fe(III) oxyhydroxide is evidently converted to magnetite by the bacteria as a byproduct of their respiration. Magnetite is formed outside the cells in copious amounts of single crystals of well defined size averaging about 60±20 nm, and morphology.

It is also known that thermophilic bacteria can reduce other metal ions, notably Cr (VI), Co (III), Ni (III), Mn (IV), and U (VI), (see, for example, Zhang et al., 1996). These studies were directed to the use of thermophilic bacteria to remediate metal-contaminated water and were conducted in cultures in the presence of only a single metal species.

### SUMMARY OF THE INVENTION

The present invention provides an apparatus to produce a wide variety of nanoparticulate mixed oxides. The apparatus takes advantage of the natural ability of selected thermophilic bacteria to efficiently reduce metal ions in the presence of a suitable electron donor, thereby providing nanoparticles uniquely suitable for producing mixed oxides as well as selected doped crystalline phases. Nanoparticles can be produced having sizes ranging generally from 10 nm to 300 nm. The size produced generally is a function of the time the process is permitted to continue.

Finely divided mixed oxides are frequently used as ceramic colorants and glazes. The oxides of cobalt are particularly well known in these applications. Because the disclosed process can reduce Co (III) to Co (II), it can be adapted to the manufacture of various mixed oxides in which cobalt oxide is the major constituent. Added oxides such as those of Fe, V, Cr, Mn, and Zn may be incorporated to change the color behavior and/or refractoriness analogous to the additions of such dopants to Fe₃O₄ and Cr₂O₃. Numerous combinations of mixed oxides can be synthesized by this route, provided only that at least one of the metals in the process can be reduced from a first valence state to a second valence state through the respiration of the bacteria.

Another aspect of the present invention is an apparatus for producing a particulate. The apparatus includes a container and a solution in the container. The solution includes a first reducible metal, a second metal, and a bacterial culture. The bacteria reduce at least a portion of the first reducible metal to form the particulate. The particulate includes at least a portion of the first metal so reduced and at least a portion of the second metal which may or may not be reduced under the culture conditions.

The first metal used in the method or apparatus may include reducible transition metals, such as Fe (III), Cr (VI), Co (III), Ni (III), Mn (IV), U (VI), or other transition elements. The second or dopant metal may include reducible or non-reducible metals, such as Fe (III), Cr (VI), Co (III), Ni (III), Mn (IV), U (VI), Ni (II), Al (III), Zn (II), Mg (II), Mn (II), Cu (II), Co (II), or Pd (II). Bacteria for use in practicing the disclosed invention are selected from among thermophilic bacteria, preferably those that are typically grown and metabolize under conditions of elevated temperature, about 42° C.-65° C., but can be grown from about 25° C.-85° C. Increased pressure may be used. However, under conditions of about 65° C. and normal atmospheric pressure conditions, mixed oxide particulates are efficiently produced.

A mixed-oxide nanoparticle includes a first metal and a second metal, at least one of the metals being a transition metal. The nanoparticle has a generally equiaxed crystallite morphology and an oxygen isotopic ratio characteristic of formation at a temperature below about 65° C. The mixed-oxide nanoparticle can have a magnetism greater than magnetite. The transitional metal can be Zn, Al, Cr, Mn, Mg, Co, Ni or Pd. The size of the nanoparticle can generally be controlled to be from about 10 nm to 300 nm in size.

The nanoparticle can provide a magnetic line width (ΔH) of at least 1800 Gauss, at least 2,000 Gauss, or more preferably, at least 2,200 Gauss.

The highly magnetic nanoparticles can be used for a variety of applications. For example, a motor can include a plurality of the nanoparticles. A magnetic storage medium can also be formed from a plurality of the highly magnetic nanoparticles.

### BRIEF DESCRIPTION OF THE DRAWINGS

A fuller understanding of the present invention and the features and benefits thereof will be accomplished upon review of the following detailed description together with the accompanying drawings, in which:

FIG. 1 is a redox potential-pH diagram illustrating regions of stability of various Fe-containing species and the electrochemical conditions established by thermophilic bacteria to facilitate the formation of magnetite.

FIG. 2 is a process diagram illustrating a method for forming a mixed constituent crystalline phase in accordance with the present invention.

FIG. 3 illustrates a batch type reactor used to produce the mixed constituent crystalline phase.

FIG. 4 illustrates a continuous type reactor used to produce the mixed constituent crystalline phase.

FIG. 5(A) and (B) are magnetic absorption spectra of magnetite and Co-doped magnetite, respectively, each synthesized by TOR-39.

FIG. 6 shows the G′ value and line-width (ΔH) derived from the FMR data shown in FIGS. 5(A) and 5(B).

FIG. 7(A) and (B) are SEM photographs of Ni-substituted magnetite (Fe₃₋ₓNiₓO₄) nanocrystals and Cr-substituted magnetite (Fe₃₋ₓCrₓO₄) nanocrystals, respectively.

### DETAILED DESCRIPTION OF THE PREFERRED EMBODIMENTS

While the invention is susceptible to various modifications and alternative forms, specific embodiments have been shown by way of example in the drawings and are described in detail. It should be understood, however, that the description of specific embodiments is not intended to limit the invention to the particular forms disclosed, but on the contrary, the intention is to cover all modifications, equivalents, and alternatives falling within the spirit and scope of the invention as defined by the appended claims.

Metal Oxide Reduction by Thermophilic Bacteria

The metabolic process in thermophilic bacteria which results in Fe (III) reduction generally involves a hydrogen electron donor and an iron Fe (III) acceptor. The hydrogen is split, yielding two hydrogen ions and two electrons. The two electrons pass through one or more metabolic processes within the bacterial cell, providing energy for the bacterium. The specific metabolic pathways have not been identified. Ultimately, two electrons are donated by the bacterial cell to a suitable electron acceptor such as Fe (III), reducing it to Fe (II).

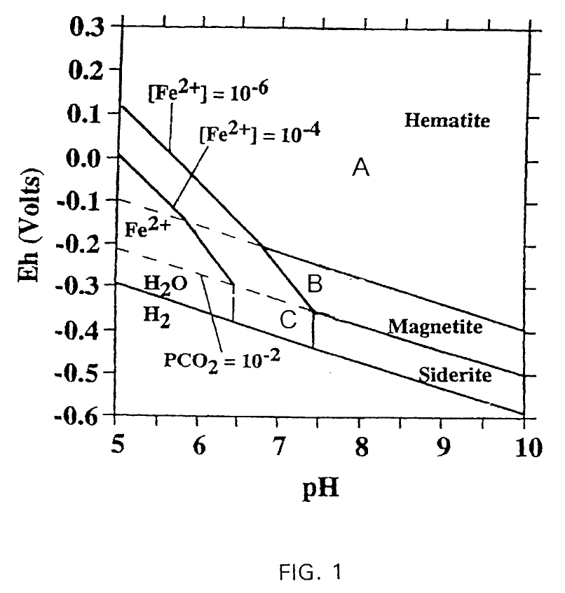

Although the exact detailed steps of the mechanism by which thermophilic bacteria reduce ions is not known with certainty, the observed results may be placed into a thermodynamic context by considering the regions of stability of the various iron-containing species in a pH-potential plot (Pourbaix diagram) as shown in FIG. 1. For purposes of illustration, the discussion below focuses on the reduction of Fe (III); however, the concepts may be applied to other metal species.

Starting with an aqueous solution at pH of 8 and zero potential (Point A), any iron present will have a valence of+3, and a suspension of hydrous Fe (III) oxides will be stable. When thermophilic bacteria are added and provided with an electron donor source such as hydrogen, the hydrous Fe (III) oxides are converted to magnetite. One can see from the formula Fe₃O₄ that in the magnetite formed, ⅔ of the Fe ions are still Fe (III). Thus, it is theorized that the bacteria are not simply “reducing Fe (III) to Fe (II)” until it is consumed, but are instead effectively moving the electrochemical potential of the system into the region where magnetite is the stable phase (Point B in FIG. 1). When all of the Fe (III) oxyhydroxide has been converted to magnetite, bacterial respiration ceases because the electrochemical potential of magnetite is such that it is not a usable electron acceptor in the bacterial system.

If one starts with a source of aqueous ferric ions such as FeO(OH) and adds an electron donor such as hydrogen (for example, by bubbling gaseous hydrogen through the solution) the equilibrium potential of the system initially lowers to some point generally indicated at Point C in FIG. 1. However, this only implies that the reaction:

3FeO(OH)+½H₂⇄Fe₃O₄+2H₂O (1)

is thermodynamically favored. Kinetic limitations effectively prevent a significant amount of product to be formed from this reaction at temperatures ranging from ambient to about 65° C.

When iron-reducing bacteria are added, the reaction proceeds to completion with substantially all FeO(OH) being converted to Fe₃O₄. Thus, in a sense, the bacteria may be considered a catalyst that facilitates the kinetics of the above reaction. In contrast to a chemical catalyst, the bacteria extract some metabolic energy to survive, so the equilibrium potential of the entire assemblage is slightly higher than it would be with the electron donor present but no bacteria, as indicated by the relative positions of Points B and C. Point B remains within the region where Fe₃O₄ is the stable phase, but now the reaction shown in Equation 1 is also kinetically favorable because of the crucial role played by bacterial respiration in splitting the hydrogen molecule and making electrons available at a suitable potential to reduce Fe (III) and form Fe₃O₄. Similar reasoning may be applied to other electron donors such as lactate, pyruvate, formate, glucose, etc., for which overall reactions analogous to the one above can be written.

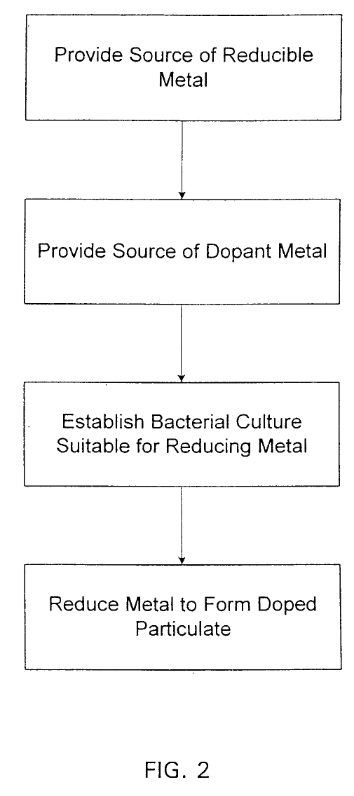

Referring to FIG. 2, a process diagram for forming a mixed constituent oxide is provided. A source of reducible metal is provided, and a source of at least one other dopant is provided. Bacterial cultures are established using bacteria suitable for reducing the metal in the presence of an electron donor. The dopant may or may not be reducible. The electron donor supports the metabolic pathway process of the bacteria that produces reduction of the metal. The bacteria reduce at least a portion of the metal to form a solid phase including at least a portion of the metal and the dopant. One or more dopants may be used and incorporated into the solid phase.

Metal Ion Reducing Bacteria

It is contemplated that at least the bacteria listed below in Table 2 may be suitable for use in the present invention.

TABLE 2

| | Locality/ | Lithology/ | In-situ | Metals | |
|---|---|---|---|---|---|
| Bacterium | Geological age | Depth | Temp. | Reduced* | |
| Thermophilic/ | Taylorsville, Virginia/ | Sediments/ | 65-85° C. | Fe, U, Mn, Co, | Liu et al., |
| TOR-39 | Triassic | >2635 m | | Cr | 1997 |
| Thermophilic/ | Parachute Pieance, | Sediments/> | 45-85° C. | Fe, U, Mn, Co, | Liu et al., |
| C1 | Colorado/Cretaceous | 840 m | | Cr | 1997 |
| Thermophilic/M3 | Parachute Pieance, | Sediments | 45-85° C. | Fe, U, Co, Cr | Liu et al., |
| | Colorado/Cretaceous | | | | 1997 |
| Psychrotrophic/ | Hawaiian deep | Iron-rich | <5° C. | Fe, Co | Stapleton et |
| PV-1 | seawater/modern | seawater | | | al., 1999 |
| Psychrophilic | Pacific deep marine | Clay and Fine | <5° C. | Fe, Co | Stapleton et |
| W3-6-1 | sediments, | sand | | | al., 1999 |
| | Wecoma/modern | | | | |
| Psychrophilic/ | Alaskan permafrost/ | Clay | <0° C. | Fe, Co | Stapleton et |
| Ak-2 | 6,000,000 yrs | | | | al., 1999 |
| Psychrophilic/ | Siberian permafrost/ | Clay and Sand | <0° C. | Fe, Co | Zhang et al., |
| W3-7 | 4,000,000 yrs | | | | 1999 |

*Batches made using glucose produced substantially all magnetite, whereas batches made with lactate or lactate/glucose mixtures produced mostly magnetite with a small amount of akaganeite in the final powders.

It is contemplated that a wide variety of electron acceptors may be used in the present invention. For example, transition elements, those with partially-filled d or f electron shells may be used. Also, elements that have partially-filled d or f shells in their commonly occurring oxidation states, such as the coinage metals, Cu, Ag, and Au may be considered transition elements for purposes of this illustration. All of these transition elements have certain general properties in common, and may be subdivided into three main groups: the main transition elements, or d-block elements; the lanthanide elements; and the actinide elements.

The reduction potentials of several metals which the bacteria are expected to reduce are given below for illustration:

| | |
|---|---|
| Fe³⁺ + e⁻ = Fe²⁺ | E⁰ = +0.77 V |
| UO₂²⁺ + 2H⁺ + 2e⁻ = U⁴⁺ + 2H₂O | E⁰ = +0.33 V |
| CO³⁺ + e⁻ Co²⁺ | E⁰ = +1.82 V |
| MnO₂ + 4H⁺ + 2e⁻ = Mn²⁺ + 2H₂O | E⁰ = +1.22 V |
| Cr₂O₇²⁻ + 14H⁺ + 6e⁻ 2Cr³⁺ + 7H₂O | E⁰ = +0.33 V |

To implement the disclosed process, an anaerobic culture vessel is provided, containing an aqueous medium in which thermophilic bacteria are grown anaerobically. Additives such as vitamins, trace elements, and other nutrients are included in the culture medium. An electron donor such as hydrogen (80% balanced with CO₂), acetate (10 mM), lactate (40 mM), pyruvate (10 mM), formate (10 mM), glucose (10 mM), or other suitable source of biologically available electrons is added to the culture medium. A reducible metal acts as an electron acceptor and is added to the medium in the form of one or more transition metals (ions or solid phases) that can be moved from a first valence state to a second valence state upon accepting electrons from the anaerobic bacteria. When the transition metal is reduced, a crystalline product is formed external to the bacterial cells, typically as minute crystals. In the case where iron (e.g., in the form of Fe (III)) is used as the electron acceptor, the solid phase formed is magnetite. The dopant is incorporated into the magnetite crystals, thus forming doped magnetite.

Exemplary electron acceptor/dopant solutions are provided below in Table 3.

TABLE 3

| Acceptor (70 mM) | Dopant | Dopant Concentration |
|---|---|---|
| Fe (III) | Cobalt (III)-EDTA | 1, 4, 6, and 10 mM |
| Fe (III) | Cobalt (II) chloride | 1, 4, 6, and 10 mM |
| Fe (III) | Chromium (VI) | 0.4, 0.6, 0.8, and 1.0 mM |
| Fe (III) | Nickel (II) | 0.5, 1.0, and 1.5 mM |
| Acceptor (70 mM) | Dopant | Dopant Concentration |
| Fe (III) | Palladium (II) | 0.4, 0.6, 0.8, and 1.0 mM |

A systematic study was undertaken in which many experimental parameters were adjusted to determine the influence of different growth conditions and electron donors on the products formed, and on the overall efficiency of production. In these studies it was found, for example, that where hydrogen was used as the electron donor and Fe (III) was the electron acceptor, the magnetite powders formed were more uniform and had a finer particle size than when pyruvate is used as an electron donor. These studies also determined that maximum cell growth and Fe (III) reduction rates were obtained at about 65° C.

Specific examples are discussed in greater detail below. All bacteria in the following examples were grown in a basal medium containing the exemplary composition shown in Table 4.

TABLE 4

| Chemical | g/L |
|---|---|
| NaCl | 10 |
| CaCl₂.2H₂O | 0.1 |
| NH₄Cl | 1.0 |
| MgCl₂.6H₂O | 0.2 |
| HEPES* | 7.2 |
| Yeast extract (composition not defined) | 0.5 |
| Vitamin solution | 1 mL |
| Trace mineral (see Table 5) | 10 mL |
| Resazurine (redox indicator) | 1 mL |

*(C₈H₁₇N₂O₄SNa), N-[2-hydroxyethyl] piperazine-N′[2-ethanesulfonic acid]

HEPES was used as a strong pH buffer because the thermophilic bacteria produce a large amount of organic acid during glucose fermentation which substantially lowers the pH. If the pH drops sufficiently, doped magnetite will not form effectively due to the higher proton concentration forcing the reduction equation in the reverse direction.

The components of the exemplary trace mineral solution are shown below in Table 5.

TABLE 5

| Chemical | g/L |
|---|---|
| nitrilotriacetic acid (C₆H₉NO₆) | 1.5 |
| FeCl₂.4H₂O | 0.2 |
| MgCl₂ . 6H₂) | 0.1 |
| Na tungstate (Na₂WO₄.2H₂O) | 0.02 |
| MnCl₂.4H₂O | 0.1 |
| CoCl₂ .6H₂O | 0.1 |
| CaCl₂.2H₂O | 0.1 |
| ZnCl₂ | 0.05 |
| CuCl₂.2H₂O | 0.002 |
| H₃BO₃ | 0.005 |
| NaMoO₄.2H₂O | 0.01 |
| NaCl | 1 |
| Na₂SeO₃ | 0.017 |
| NiCl₂. 6H₂O | 0.024 |

TABLE 6

| Vitamin | g/L |
|---|---|
| Biotin | 0.02 |
| Folio acid | 0.02 |
| B6 (pyridoxine)HCl | 0.1 |
| B1 (thiamine)HCl | 0.05 |
| B2 (riboflavin) | 0.05 |
| Nicotinic acid (niacin) | 0.05 |
| Pantothenic acid | 0.05 |
| B12 (cyanocobalamine) | 0.001 |
| PABA (p-aminobenzoic acid) | 0.05 |
| Lipoic acid (thioctic) | 0.05 |
| Distilled H₂O | 1L |

A large number of possible uses are contemplated for the particulate products. These include: microwave-absorbent materials and paints to suppress stray reflections on antenna structures; ceramic pigments; magnetic powders for recording media, xerographic toners, and magnetorheological media, and precursor materials for fabrication into magnets and other electronic devices.

The present invention involves advantageously using the respiration process of anaerobic bacteria, such as those described above, to manufacture nanocrystals for a variety of applications by the selective reduction of metal ions to form desired crystalline phases with mixed constituents, such as magnetite, maghemite, and other spinel compounds, as well as various other mixed oxides.

It has been found that if the magnetite is doped with certain metals, the material formed can be more magnetic as compared to magnetite. For example, TOR-39 synthesized magnetite mixed with either Co, Ni and Pd have all be found to result in compositions having a magnetism greater than TOR-39 synthesized magnetite.

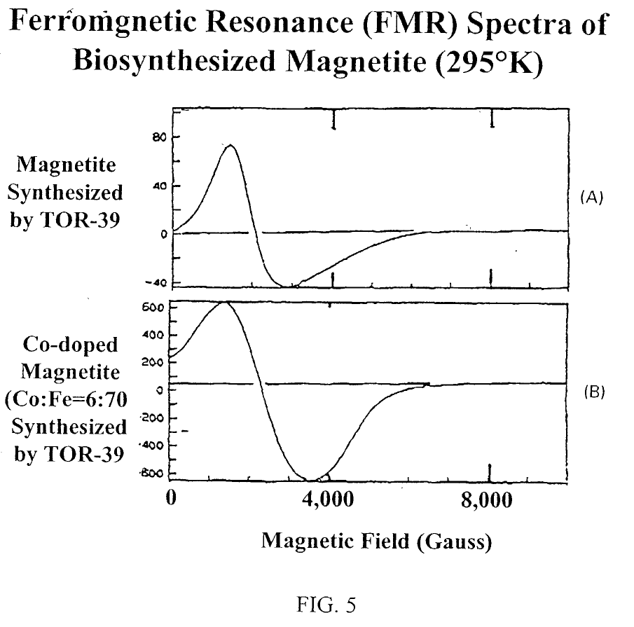

FIG. 5(A) and (B) show absorption spectra at 295 K for magnetite and Co-doped magnetite, respectively, each synthesized by TOR-39. The Co: Fe wt % ratio in the doped material analyzed was approximately 6:70. These figures show the microwave power absorbed by the magnetite and Co doped magnetite as a function of the applied magnetic field. In ferromagnetic resonance (FMR), when a magnetization vector is subject to a static magnetic field and a perpendicularly applied pump field, resonance will occur at a frequency more or less proportional to the strength of the static field. The microwave power absorbed by the magnetic sample as a function of frequency will typically be a lorentzian centered at resonance.

The absorption spectra of Co-doped magnetite shows drawn-out absorption on the low field side of the absorption peak. The Co (III)-doped magnetite samples have the least drawn-out HIGH-field assymetry. These results are consistent with the FMR spectra of ferrites which contain a significant amount of cobalt.

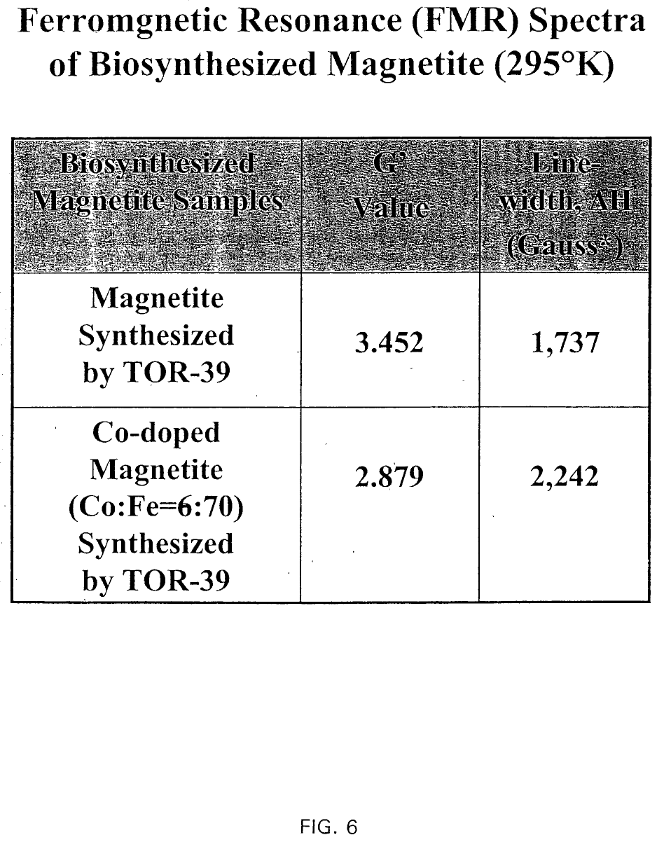

FIG. 6 shows the G′ value and line-width (ΔH) derived from the FMR data shown in FIGS. 5(A) and 5(B). Co-doped magnetite shows greater magnetism (ΔH=2,242) than the magnetism (ΔH=1,737) exhibited by magnetite without metal doping.

As shown above, the invention can be used to produce particles having a magnetism greater than undoped magnetite. The nanoparticles produced can provide a magnetic line width (ΔH) of at least 1800 Gauss, at least 2,000 Gauss, or more preferably, at least 2,200 Gauss.

The ability to synthesize particles having a magnetism greater than magnetite coupled with the ability to produce a controllable particle size capable of reaching into the low nm range makes the invention suitable for use in a wide variety of applications.

Some typical applications for these nanocrystals include magnetorheological media, magnetic storage, dry printing, and magnetic devices. Particles having a magnetism greater than magnetite can be used to make nanosize highly magnetic coatings that can be used by the computer industry to form faster magnetic disks. Faster and more efficient motors may also be produced using the invention. Faster motors can be used for improved drills, as well as a variety of other uses.

The process to form the mixed oxide nanoparticles is fairly predictable since the respiration process of the thermophilic bacteria effectively creates a nonselective source of electrons at an essentially constant electrochemical potential. Culturing the bacteria with a mixture of transition metal electron acceptors yields a precipitate including a single-phase crystalline oxide containing this mixture of metals. With proper nutrients including Fe (III) and other transition metal ions, the bacteria can establish an Eh and pH where magnetite is stable, and the other transition metal ions are incorporated into the magnetite as it forms, thus yielding selectively doped ferrite materials. Generally, when producing a “doped” magnetite, the stability field for the doped magnetite should not be so different from that of “pure” magnetite that it cannot be reached by the potential imposed by the bacterial respiration process.

The bacteria can insert metal species in the nanoparticles that are themselves not reducible by the bacteria. For example, metal ions such as Zn (II) may be incorporated into growing magnetite even though the bacteria are not reducing the zinc ions, just as unreduced Fe (III) ions are incorporated into “undoped” magnetite. By analogous reasoning, those of ordinary skill in the art will appreciate that adding some Fe (III) to a culture in which the bacteria are reducing Cr (VI) to Cr (III) may yield an Fe-doped Cr₂O₃. Similarly, a mixture of Fe (III) and Cr (VI) in a 1:2 ratio may yield FeCr₂O₄. Hence, it can be seen that the inventive process may be used to create virtually unlimited combinations of mixed oxides.

Because the process used to form magnetite or doped magnetite described herein is performed at ambient or near ambient temperatures (<100°C.), unique ferrites that cannot be synthesized by calcining or other processes that take place at elevated temperatures (e.g., calcining of oxides or carbonates at 500° C.) may be formed. For example, many of the constituents of advanced ferrites can be either di- or trivalent, and the distribution of these is thermodynamically controlled. In particular, at higher temperatures, entropy effects will tend to encourage a distribution among+2 and+3 or between octahedral and tetrahedral sites. Synthesizing the compound at near ambient temperatures may encourage a more effective segregation of certain species, e.g., Ni or Co, to certain sites. This could be especially important for products that use the magnetite in a powdered form that will not later be sintered (recording media, toner for xerographic copiers, etc.) because sintering would cause the partitioning of chemical species to revert to the high-temperature distribution.

Also, due to the low temperature process (e.g. 65°C.), the isotopic concentrations of certain ions, such as ¹⁸O, differ from the concentrations found in oxides formed using conventional methods, as shown in C. Zhang et al., (1997). These characteristic isotopic concentrations are useful in identifying products formed in accordance with the present invention.

Another distinguishing characteristic of nanoparticles formed in accordance with the invention is the generally equiaxed morphology. Although it may be possible using other methods to form mixed-oxide nanoparticles at a temperature approaching 65° C., the resulting crystallite morphology generally is asymmetric in the three coordinate directions, such as a acicular.

### EXAMPLES

### Example 1

### Production of Zinc (II) Doped Magnetite

This example illustrates that conditions can be established in a thermophilic bacterial culture in which a selected mixed oxide phase is thermodynamically stable. This stable phase allows incorporation of ions into a magnetite particulate regardless of whether or not the ions are themselves reduced by the bacteria. In the illustration, Zn (II) is originally present in the solution and remains in the+2 valence state when incorporated into the structure of magnetite.

Doped magnetite was formed by a pure culture of bacteria strain TOR39 (Thermoanerobacter) growing on lactate as an electron donor. Freshly grown cultures were transferred into the basal medium (Table 4). Sterile amorphous Fe (III) oxyhydroxide (final concentration 70 mM) was added as the electron acceptor. Alternatively, sterile glucose (0.2% final concentration) could be employed as the electron donor. H₂ (80%, balanced with 20% CO₂) was added as an electron donor. Amorphous Fe (IIIl) oxyhydroxide was formed by adding 0.4M FeCl₃ and 10M NaOH to precipitate the poorly crystalline precursor.

Anaerobic ZnCl₂ (final concentration 5 mM) was added as a dopant. The ZnCl₂ solution was flushed with N₂ gas and then autoclaved prior to microbiological use in order to remove dissolved oxygen. Incubation was at 65° C. for one week. Under these conditions, the bacteria produced a fine brown magnetic oxide powder. The solid material was washed three times with distilled water, dried under N₂, and stored in vacuum before analysis. Semiquantitative SEM/EDS analysis revealed that the powder contained Zn (estimated at several percent) and X-ray diffraction showed the material to be predominantly magnetite.

A thick layer of magnetic particles formed on the bottom of the vessel. The particulate product formed outside of the bacterial cell, allowing the product to be harvested without killing the bacteria. The ratio of product to biomass was approximately 85 g per 1 g dry weight of cells.

### Example 2

### Production of Cobalt Doped Magnetite

A batch was prepared using the same procedure as in Example 1 above, with the addition of anaerobic cobalt (III) EDTA (final concentration 1 mM) as a dopant. Incubation was at 65° C. for one week. A fine black powder was formed containing about 85 g magnetite in 8 L medium. The solid material was washed three-times with anaerobic distilled water, dried under N₂, and stored in vacuum before analysis. The amount of Co in the final product was not determined. SEM/EDS analysis was inconclusive because of overlapping peaks; however, the material was strongly magnetic, having a magnetism greater than magnetite alone.

### Example 3

### Production of Doped Ferrites

Additional experiments were conducted to demonstrate the growth of doped ferrites using several different compositions as shown below in Table 7. All batches were made using bacterial strain TOR39 and yielded magnetite as the major phase after incubation at 65° C. The control experiments had no bacteria and the solid phase was akaganeite (i.e., no conversion to magnetite took place).

TABLE 7

| | | | | Minero- |
|---|---|---|---|---|
| | | | | logy |
| | | Dopant: | | (Major |
| Sample | Electron Donor | Fe Ratio | Dopant source | Phase)* |
| 1 | glucose | Co:Fe 6:70 | CoCl₂ | magnetite |
| 2 | glucose | Co:Fe 6:70 | Co (III)-EDTA | magnetite |
| 3 | glucose | Cr:Fe 0.6:70 | K₂CrO₄ | magnetite |
| 4 control | lactate | Co:Fe 6:70 | CoCl₂ | akaganeite |
| 5 | lactate | Co:Fe 4:70 | CoCl₂ | magnetite |
| 6 | lactate | Co:Fe 4:70 | CoCl₂ | magnetite |
| 7 | lactate/glucose | Co:Fe 6:70 | CoCl₂ | magnetite |
| 8 | lactate | Co:Fe 6:70 | CoCl₂ | magnetite |
| 9 | lactate/glucose | Co:Fe 10:70 | CoCl₂ | magnetite |
| 10 | lactate | Co:Fe 10:70 | CoCl₂ | magnetite |
| 11 | lactate/glucose | Co:Fe 12:70 | CoCl₂ | magnetite |
| 12 | lactate | Co:Fe 12:70 | CoCl₂ | magnetite |
| 13 control | lactate | Co:Fe 6:70 | Co (III)-EDTA | akaganeite |
| 14 | lactate | Co:Fe 4:70 | Co (III)-EDTA | magnetite |
| 15 | lactate | Co:Fe 4:70 | Co (III)-EDTA | magnetite |
| 16 | lactate/glucose | Co:Fe 6:70 | Co (III)-EDTA | magnetite |
| 17 | lactate | Co:Fe 6:70 | Co (III)-EDTA | magnetite |
| 18 | lactate/glucose | Co:Fe 10:70 | Co (III)-EDTA | magnetite |
| 19 | lactate | Co:Fe 10:70 | Co (III)-EDTA | magnetite |
| 20 | lactate/glucose | Co:Fe 12:70 | Co (III)-EDTA | magnetite |
| 21 | lactate | Co:Fe 12:70 | Co (III)-EDTA | magnetite |
| 22 control | lactate | Cr:Fe 0.6:70 | K₂CrO₄ | akaganeite |
| 23 | lactate | Cr:Fe 0.6:70 | K₂CrO₄ | magnetite |
| 24 | lactate | Cr:Fe 0.6:70 | K₂CrO₄ | magnetite |
| 25 | lactate | Cr:Fe 0.8:70 | K₂CrO₄ | magnetite |
| 26 | lactate | Cr:Fe 0.8:70 | K₂CrO₄ | magnetite |
| 27 | lactate | Cr:Fe 1:70 | K₂CrO₄ | magnetite |
| 28 | lactate | Cr:Fe 1:70 | K₂CrO₄ | magnetite |

Batches made using glucose produced substantially all magnetite, whereas batches made with lactate or lactate/glucose mixtures produced mostly magnetite with less than 10% of akaganeite in the product based on semiquantitative XRD analyses.

### Example 4

### Scale-Up Processes

This example illustrates that the disclosed process can be scaled up easily by making a bioreactor of any desired size.

Scale-up experiments were conducted using 160 mL, 1000 mL, 2000 ml, 13.25 L, and 20 L serum bottles. Each batch was prepared using the same procedure as in Example 1 above, except that glucose (10 mM concentration) was substituted for hydrogen as the electron donor. The amounts of the various components were glucose: amorphous iron: innoculum: medium=1:5:2:50.

Three samples from the 1000 mL bottles (two were doped with Co (III) to a final concentration of 1, 4, 6, and 10 mM and one with Cr (VI) to a final concentration of 0.4, 0.6, 0.8 and 1.0 mM) yielded from 1.2 to 3 g of magnetite powder each.

After culturing for 22 days, the sample harvested from the 13.25 L bottle yielded about 85 g of magnetite powder after washing. One Cr-doped sample was analyzed by semiquantitative EDX and contained about 1-2% Cr. One sample of Co-doped magnetite was mounted in epoxy and polished in order to analyze the interiors of several particles by wavelength dispersive x-ray analysis. This analysis was done to confirm that the dopant was in fact incorporated into the crystallites and not merely adsorbed onto the surface of the crystals. Analysis showed approximately 0.3-0.5 at. % Co was present throughout the particle interiors, representing substitution for about 1% of the Fe in the magnetite structure.

Control samples (no bacteria present) were examined using XRD analyses. The mineral phase present was demonstrated to be akaganeite (FeOOH). Thus, no Fe (III) reduction had taken place in the absence of bacteria, and the batch did not produce magnetite. In these experiments, more efficient metabolism (faster growth rate) was observed using glucose instead of hydrogen as the electron donor and the rate of magnetite production was increased.

### Example 5

### Production of Fe (III) Doped Chromium Oxide

The disclosed process may be used with different combinations of mixed oxides, particularly for many potentially useful materials besides magnetite or other ferrites. In this example, Cr₂O₃ doped with Fe (III) was prepared. It is contemplated that small amounts of Al (III) can also be incorporated into Cr₂O₃ by a similar procedure.

A doped Cr₂O₃ material was prepared by adding dopant ions to a thermophilic TOR39 bacterial culture solution along with a source of hexavalent chromium. A source of Fe (III) and Cr (VI) were provided and incubated to allow the bacteria to reduce the electrochemical potential to the point where Cr₂O₃ stably precipitated. Fe (III) became incorporated into this phase even though it had not been reduced.

In a 100 mL serum bottle, a culture was grown at 65° C. for four weeks using iron reducing medium, 10 mM glucose, 0.75 mM potassium chromate and 0.075 ferric citrate and using bacterial strain TOR39 Thermoanerobactor with glucose as the electron donor. A green powder precipitated in the culture within a week. The precipitates formed through bacterial reduction of Cr (VI). Cr₂O₃ and Fe₂O₃ form a binary solid solution series. The iron present was inferred to be

incorporated into the Cr₂O₃ phase, because no magnetite was observed in the product. This example demonstrates that the invention works with chromium (III) oxide as the target matrix phase and without the reduction of iron (III). Therefore, the biogenic process for forming mixed-oxide compounds does not necessarily produce magnetite nor does the process necessarily require a supply of iron (III).

### Example 6

### Batch Process Reactor

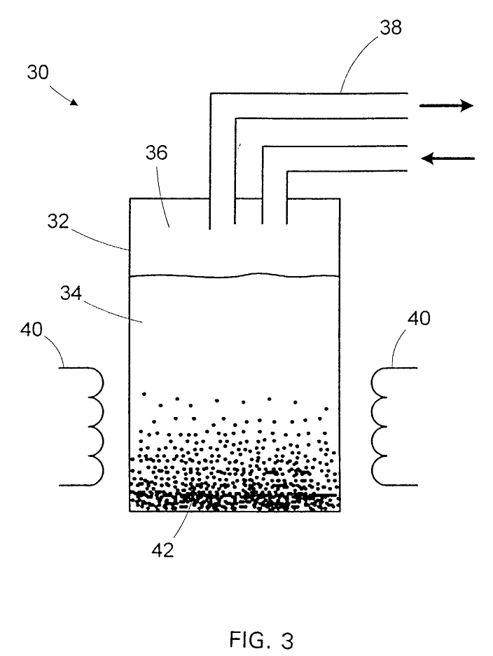

FIG. 3 is a simplified diagram of a batch type bioprocessing reactor 30 suitable for carrying out the inventive process shown in FIG. 2. The reactor includes a container 32 constructed of glass or other inert material. A culture medium 34 is introduced in the container 32. The culture medium 34 contains an aqueous solution of nutrients, trace elements, vitamins, and other organic and inorganic compounds as described in the foregoing examples. The solutions described above are provided for illustrative purposes. Other solution constructs are possible, depending on the specific implementation.

The container 32 is sealed to prevent the entry of air into the headspace gas region 36 thereby maintaining anaerobic conditions within the culture as well as permitting the inventive process to be carried out at pressures greater or less than ambient if desired. A gas conduit 38 is included to allow the introduction of selected gases into the container and to allow gases to exit the container. A heating element 40 is provided proximate the container 32 to maintain the culture medium 34 at a desired temperature for growth of the anaerobic, thermophilic bacteria. An electron donor is introduced into the culture either as a gas (such as hydrogen or CO) through the gas conduit 38, or dissolved directly into the culture medium 34 in the case of simple organics such as glucose, lactate, and pyruvate. An electron acceptor is provided in the form of one or more reducible transition elements, such as Fe (III), Cr (VI), Co (III), Ni (III), Mn (IV), and U (VI), etc. dissolved or suspended in the culture medium 34. One or more additional dopant metal species, which may or may not be reducible, are provided in the culture medium 34. If the dopant species is not reducible, for example Zn (II), it is generally present at a lower concentration than the reducible species. Exemplary dopant metals may include reducible or non-reducible metals, such as Fe (III), Cr (VI), Co (III), Ni (III), Mn (IV), U (VI), Ni (II), Al (III), Zn (II), Mg (II), Mn (II), Cu (II), Co (II), or Pd (II).

In a particular embodiment, the pH is maintained at a level between about 6.9 and 7.5, and the solution is maintained at a temperature of between about 45° C. and 75° C. Specific temperature and pH may be varied to optimize product yield, and the optimum values depend on factors including the particular mixed oxide being formed.

A crystalline product 42 forms in the container 32 as the bacteria reduces the reducible species. The dopant species is incorporated into the crystalline product 42, for example, Fe₃O₄, created through the reduction of the major metal species. When a sufficient quantity of crystalline product 42 has been produced and allowed to settle to the bottom of the container 32, the culture medium 34 is decanted and the crystalline product 42 is collected and washed. The incubation may be between 3 and 30 days, depending on the amount and size of the crystalline product desired.

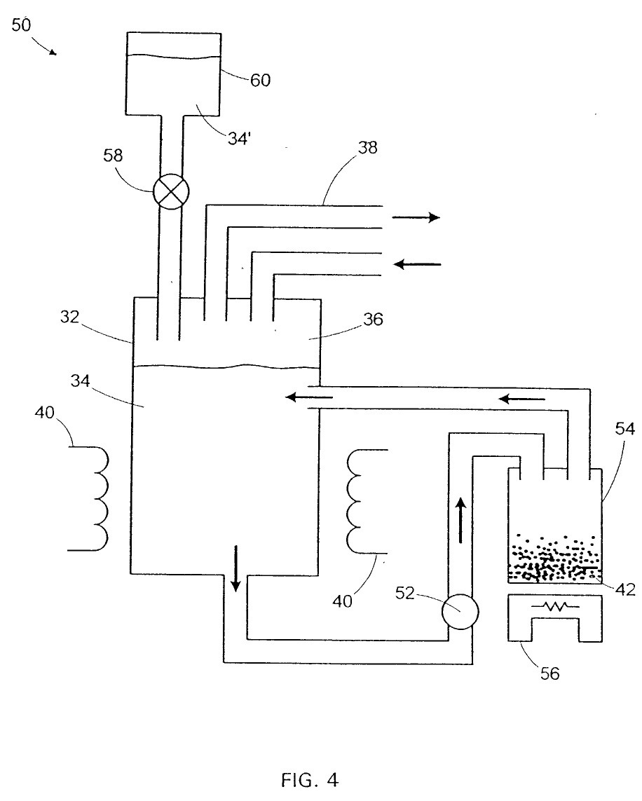

The disclosed process may also be performed in a continuous arrangement as shown schematically by the bioreactor 50 shown in FIG. 4. The bioreactor 50 operates in a similar manner as the bioreactor 30 of FIG. 3. The bioreactor 50 includes a fluid recirculator 52 that allows the culture medium 34 to pass through an external trap 54 from which the crystalline product 42 can be removed. The trap 54 may separate the crystalline product, 42 from the circulating culture medium by settling, due to the greater density of the crystalline product 42. In many cases, the crystalline product 42 is magnetic, and the collection process can be assisted by using an electromagnet 56 or other suitable field producing device to provide a magnetic field gradient in the trap 54.

Continuous collection of product from the circulating fluid may also be used as a means of controlling particle size, because the particles tend to grow larger the longer they remain in the culture. An additional fluid valve 58 may be provided through which additional culture medium or nutrients 34 may be added from an external reservoir 60 while maintaining the anaerobic conditions within the container 32.

The composition of the culture medium 34 may be changed periodically in order to make crystalline products 42 of various selected compositions. The electron acceptor may be adjusted during the process, to make, for example, particles with a compositionally zoned or layered structure for special applications.

### Example 7

### Characteristics of Biogenic Ferrites

The particulates made by the inventive process have a unique combination of characteristics that will allow the skilled artisan to distinguish them from similar materials made by other processes.

First, as discussed in detail in Zhang et al., [Geochem. et Cosmochem. Acta 61[21], pp. 4621-32 (1997)] the oxygen isotopic ratios can provide clear evidence that the particles were made at a temperature of 65° C. or below. This is below the temperature range of conventional inorganic synthesis processes. Certain inorganic methods, such as the unpublished method of D. R. Cole et al. described in Zhang, can in principle be extended down to slightly overlap the optimal temperature range of Applicants' process. However, the crystallinity and phase purity of the product is known to degrade and the particle morphology is more acicular and less equiaxed than the inventive particles when the inorganic process is carried out at about 65° C.

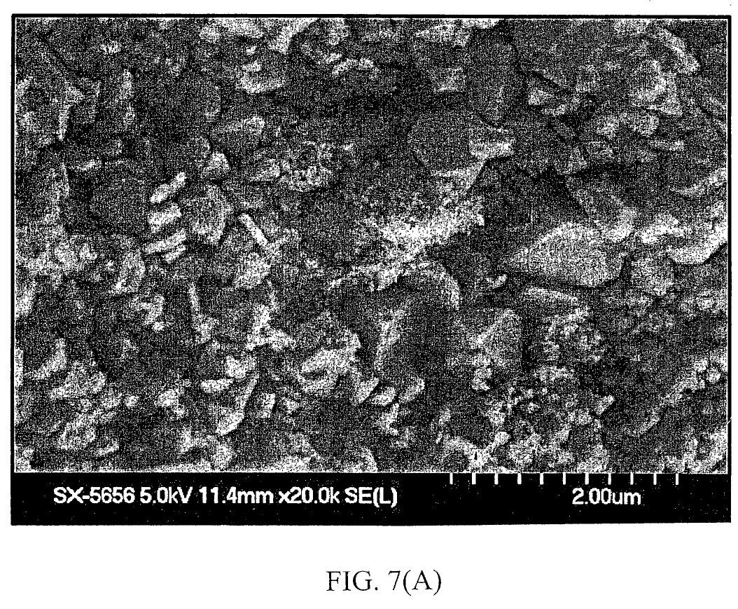

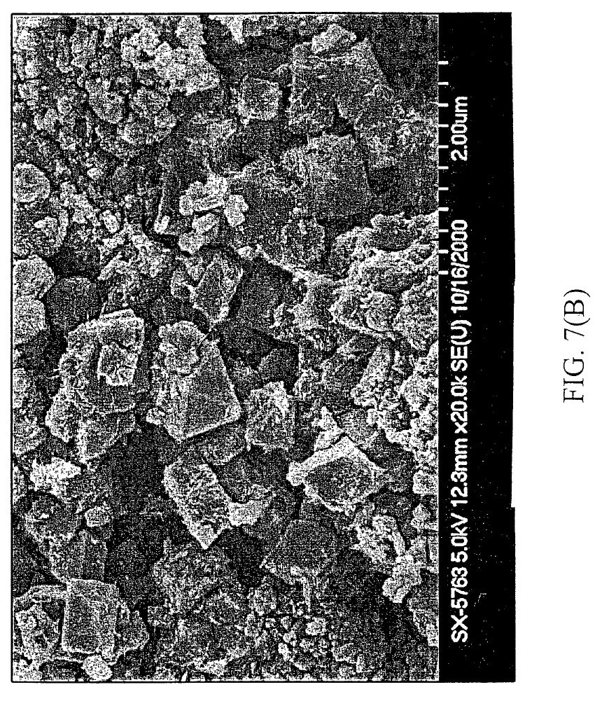

FIGS. 7(A) and 7(B) are SEM photographs of Ni-substituted magnetite (Fe₃₋ₓNiₓO₄) nanocrystals and Cr-substituted magnetite (Fe₃₋ₓCrₓO₄) nanocrystals, respectively. The nanocrystals were formed by microbial synthesis at a temperature of about 65° C. These FIGS. show well-formed octahedra product crystals. The lighter gray powdery material is likely remnant FeO(OH) starting material, and possibly some salt from the culture medium.

Second, although magnetite particles made by magnetotactic bacteria at similar temperatures to the inventive material (and therefore have similar oxygen isotopic ratios), may have generally equiaxed crystallites, those crystals are known to be pure iron oxide crystallites since they are grown within the bacterium by a membrane-controlled process. Thus, the inventive mixed-oxide particles may be clearly recognized as not derived from magnetotactic bacteria due to the presence of one or more metals other than Fe.

With further study, skilled artisans will likely identify further distinguishing characteristics of nanoparticles produced using the invention, such as iron isotopic ratios and dopant site occupancies.

Although many of the examples described herein are directed to the formation of mixed ferrites, it is contemplated that the technique may be used to produce other mixed metal oxide compositions, particularly those that might benefit from low-temperature synthesis as described above.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

### REFERENCES CITED

Zhang, C. et al., “Enhancement of Fe(III), Co(III) and Cr(VI) Reduction at Elevated Temperatures and by a Thermophilic Bacterium”, Appl. Biochem. and Biotech., 57-58, pp.923-32, (1996)

Zhang, C. et al. “Physiochemical, mineralogical, and isotopic characterization of magnetite-rich iron oxides formed by thermophilic iron-reducing bacteria”, Geochimica et Cosmochimica Acta. Vol. 61 No. 21. pp. 4621-4632 (1997)

Zhang, C. et al., “Iron reduction by psychrotrophic enrichment cultures”, FEMS Microbiology Ecology, Vol. 30 pgs. 367-371 (1999)

We claim:

1. An apparatus for producing mixed-oxide nanoparticles, comprising:
a container;
a solution in said container, said solution including a source of ions of a first reducible metal, a source of ions of a second metal, at least one of said metals being a transition metal, said first metal being different from said second metal, a supply of thermophilic bacteria, and an electron donor source, wherein said thermophilic bacteria reduces said ions of at least one of said transition metals to form mixed-oxide nanoparticles in the presence of said electron donor source, said mixed-oxide nanoparticles comprising both said first and second metals.

2. The apparatus of claim 1, wherein the electron donor comprises at least one selected from the group consisting of formate, glucose, acetate, lactate, pyruvate and hydrogen.

3. The apparatus of claim 1, wherein the solution is maintained in an anaerobic environment.

4. The apparatus of claim 1, wherein the thermophilic bacteria comprises a Thermobacter strain of TOR39 bacteria.

5. The apparatus of claim 1, wherein said first reducible metal includes at least one selected from the group consisting of Fe (III), Cr (VI), Co (III), Ni (III), Mn (IV) and U (VI).

6. The apparatus of claim 1, wherein a second metal is reducible by said bacteria.

7. The apparatus of claim 1, wherein a second metal is not reducible by the bacteria.

8. The apparatus of claim 1, wherein a second metal includes at least one of Fe (III), Cr (VI), Co (III), Ni (III), Mn (IV), U (VI), Ni (II), Al (III), Zn (II), Mg (II), Mn (II), Cu (II), Co (II) and Pd (II).

9. The apparatus of claim 1, wherein a first reducible metal comprises a suspension of iron oxyhydroxide, and the particulate comprises magnetite doped with at least a portion of the second metal.

10. The apparatus of claim 1, wherein the pH of the solution is between about 6.2 and 8.5.

11. The apparatus of claim 1, further comprising a heating element proximate the container adapted to control the temperature of the solution.

12. The apparatus of claim 1, wherein the temperature of the solution is between about 45° C. and 75° C.

13. The apparatus of claim 1, further comprising:
a fluid reservoir;
a second solution in the fluid reservoir; and
a fluid conduit for coupling the fluid reservoir to the container; and
a valve in the fluid conduit for controlling flow of the second solution into the container.

14. The apparatus of claim 1, wherein the second solution comprises a source of at least one of the first reducible metal, the second metal, and the bacterial culture.

15. The apparatus of claim 1, wherein the second solution includes a source of the first reducible metal and the second metal at a different concentration than the first solution.

16. The apparatus of claim 1, wherein said mixed-oxide nanoparticle has a magnetism greater than magnetite.

17. The apparatus of claim 1, wherein said transitional metal is at least one selected from the group consisting of Co, Ni and Pd.

18. The apparatus of claim 1, wherein said nanoparticle is from about 10 nm to about 300 nm in size.

19. A mixed-oxide nanoparticle, comprising:
a first metal,
a second metal, at least one of said metals being a transition metal, said first metal being different from said second metal, said nanoparticle having a generally equiaxed crystallite morphology and an oxygen isotopic ratio characteristic of formation at a temperature below about 65° C.

20. The nanoparticle of claim 19, wherein said transitional metal is at least one selected from the group consisting of Zn, Al, Cr, Mn, Mg, Co, Ni and Pd.

21. The nanoparticle of claim 19, wherein said nanoparticle is magnetic, said nanoparticle having a line width (ΔH) of at least 1,800 Gauss.

22. The nanoparticle of claim 19, wherein said nanoparticle is magnetic, said nanoparticle having a line width (ΔH) of at least 2,000 Gauss.

23. The nanoparticle of claim 19, wherein said nanoparticle is magnetic, said nanoparticle having a line width (ΔH) of at least 2,200 Gauss.

24. The nanoparticle of claim 19, wherein said nanoparticle is from about 10 nm to about 300 nm in size.

25. A motor including a plurality of the nanoparticles of claim 21.

26. A magnetic storage medium including a plurality of the nanoparticles of claim 21.
